(19) United States
(12) Patent Application Publication
(10) Pub. No.: US 2026/0065555 A1
(43) Pub. Date: Mar. 5, 2026

(54) DENOISING DIFFUSION MODELS FOR PLUG-AND-PLAY SIMULTANEOUS MULTISLICE MRI RECONSTRUCTION

(71) Applicants: Siemens Healthineers AG, Forchheim (DE); New York University, New York, NY (US)

(72) Inventors: Mahmoud Mostapha, Princeton, NJ (US); Radu Miron, Iasi (RO); Mariappan S. Nadar, Plainsboro, NJ (US); Gregor Körzdörfer, New York, NY (US); Esther Raithel, Dormitz (DE); Jan Fritz, Baltimore, MD (US)

(21) Appl. No.: 19/068,920

(22) Filed: Mar. 3, 2025

Related U.S. Application Data
(60) Provisional application No. 63/687,798, filed on Aug. 28, 2024.

(30) Foreign Application Priority Data
Aug. 28, 2024 (EP) 24465566.8

(51) Int. Cl. G06T 11/00; G06T 7/00

(52) U.S. Cl. CPC G06T 12/00; G06T 7/00; G06T 2207/10088; G06T 2210/41

(57) ABSTRACT

Systems and methods for image reconstruction of simultaneous multi-slice (SMS) magnetic resonance data using diffusion models. An SMS diffusion plug and play model is based on DDIM and supports fast sampling. The SMS diffusion plug and play model includes data consistency based on a data proximal subproblem that incorporates an SMS imaging model.

### CROSS REFERENCE TO RELATED APPLICATIONS

This application claims priority to U.S. provisional application Ser. No. 63/687,798, filed Aug. 28, 2024, and European Patent Application EP24465566.8, filed Aug. 28, 2024, both of which are entirely incorporated by reference.

### FIELD

This disclosure relates to medical imaging.

### BACKGROUND

Magnetic resonance imaging, or MRI, is a noninvasive medical imaging test that can generate detailed images of almost every internal structure in the human body, including, for example organs, bones, muscles, and blood vessels. Traditional MRI is slow due to the need for sequential data acquisition, often resulting in long scan times that can cause patient discomfort and motion artifacts. Acceleration techniques aim to overcome these limitations using methods like parallel imaging (PI), compressed sensing (CS), and deep learning-based reconstructions. These techniques may use multiple receiver coils to acquire data simultaneously, reducing scan time. Simultaneous multi-slice (SMS), for example, is a magnetic resonance imaging (MRI) acceleration technique that utilizes multi-band radio-frequency pulses to simultaneously excite and encode multiple slices.

The combination of parallel imaging (PI) and simultaneous multi-slice (SMS) acceleration has realized clinical 4-fold accelerated (S2P2; 2-fold SMSx2-fold PI) 2D TSE MRI of the knee and other peripheral joints. However, 6-fold S2P3 and 8-fold S2P4 acceleration with conventional reconstruction methods suffer from a significant image quality degradation, including a large drop in the signal-to-noise ratio (SNR) and the presence of inter-slice leakage and aliasing artifacts. Deep learning (DL) based approaches have been proposed that use neural networks to enhance image reconstruction, improving speed and accuracy. A DL framework for combined slice separation and k-space-to-image reconstruction of SMS-PI-accelerated MRI scans has been used that unrolls a proximal gradient algorithm. However, such a method at higher accelerations still has generalization issues.

### SUMMARY

By way of introduction, the preferred embodiments described below include methods, systems, instructions, and/or computer readable media for magnetic resonance imaging and image reconstruction using denoising diffusion models for SMS MR image reconstruction.

In a first aspect, a method for diffusion plug and play (PnP) image reconstruction of SMS medical imaging data, the method comprising: acquiring simultaneous multi-slice (SMS) medical imaging data of a patient; iteratively refining the SMS medical imaging data using a SMS diffusion PnP model, wherein for each step of an iterative process of the SMS diffusion PnP model, a pretrained diffusion model is used to remove noise to predict a next state of the iterative process and a data consistency step is applied that incorporates a SMS imaging model; and outputting reconstructed SMS medical imaging data of the patient.

In a second aspect, a system for diffusion plug and play (PnP) image reconstruction of magnetic resonance (MR) data, the system comprising: a medical imaging device configured to acquire simultaneous multi-slice (SMS) medical imaging data of a patient; a memory configured to store a model configured to reconstruct one or more MR images when input the SMS medical imaging data, wherein the model is configured to iteratively refine the SMS medical imaging data using diffusion, wherein for each step of the iterative process, a pretrained diffusion model is used to remove noise to predict a next state of the iterative process and data consistency is performed by solving a data proximal subproblem; and a processor configured to reconstruct and/or restore the reconstruct one or more MR images from the SMS medical imaging data using the model.

In a third aspect, a method for diffusion plug and play (PnP) image reconstruction of medical imaging data, comprising: acquiring, by an magnetic resonance scanner, simultaneous multi-slice (SMS) medical imaging data; iteratively reconstructing the SMS medical imaging data using a SMS diffusion PnP model that includes data consistency during reverse diffusion steps; and outputting a reconstructed image.

Any one or more of the aspects described above may be used alone or in combination. These and other aspects, features and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 depicts an example system for acquisition and reconstruction of SMS medical imaging data using diffusion according to an embodiment.

FIG. 2 depicts an example of a generative diffusion process.

FIG. 3 depicts an example method for acquisition and reconstruction of SMS medical imaging data using diffusion according to an embodiment.

FIG. 4 depicts a step for reconstruction of SMS medical imaging data using diffusion according to an embodiment.

FIG. 5 depicts the data consistency step for reconstruction of SMS medical imaging data using diffusion according to an embodiment.

FIG. 6 depicts a SMS diffusion PnP model according to an embodiment.

FIG. 7 depicts an example workflow for training a SMS diffusion PnP model according to an embodiment.

FIG. 8 depicts an example U-net architecture.

FIG. 9 depicts an example artificial neural network.

FIG. 10 depicts an example convolutional neural network.

### DETAILED DESCRIPTION

Embodiments described herein provide systems and methods that combine a traditional plug-and-play method with a diffusion sampling framework to accurately reconstruct complex SMS MRI data with a limited number of Neural Function Evaluations (NFEs) while preserving overall image quality and generalizing well to unseen datasets.

MRI is a widely used medical imaging technique that provides high-resolution anatomical and functional imaging without ionizing radiation. However, MRI acquisitions are often slow, leading to long scan times and patient discomfort. To address this issue, researchers have explored deep learning-based methods for accelerating MRI reconstruction from undersampled data which may be acquired in shorter imaging sessions. Simultaneous multi-slice (SMS) is a magnetic resonance imaging (MRI) acceleration technique that speeds up imaging sessions. The fundamental principle behind SMS imaging is the simultaneous excitation of multiple slices using a single radiofrequency (RF) pulse modulated with different phase shifts. The different phase shifts are designed to ensure that the signals from different slices may be separated later during image reconstruction. Conventional MRI acquires slices sequentially, whereas SMS imaging dramatically increases acquisition efficiency by encoding multiple slices within the same repetition time (TR), effectively shortening overall scan duration.

To unalias the overlapping signals from different slices, SMS employs techniques such as controlled aliasing in parallel imaging (CAIPI) and multi-channel coil sensitivity encoding. CAIPI introduces deliberate shifts in slice positioning to reduce slice-to-slice signal interference while the parallel imaging exploits the spatially varying sensitivity profiles of multi-channel receiver coils to disentangle overlapping slice signals. The combination of these approaches enhances the accuracy of slice separation and improves image quality.

The application of SMS imaging is particularly useful in functional MRI (fMRI) and diffusion-weighted imaging (DWI). In fMRI, where temporal resolution is critical for capturing rapid neural activity, SMS enables higher sampling rates, reducing the delay between successive images and increasing statistical power in brain activity measurements. In DWI, which relies on the detection of water molecule diffusion to characterize tissue microstructure, SMS facilitates the acquisition of high-resolution diffusion maps in a much shorter time, improving signal-to-noise ratios and reducing artifacts associated with patient motion. SMS, however, is not without its own challenges particularly in image reconstruction and restoration. With the increasing success of deep learning (DL) accelerated MRI reconstruction models, a dedicated approach incorporating the SMS imaging model into a DL framework is highly desirable to enable an end-to-end framework for optimal reconstructions tailored for this use case.

Supervised learning methods have been used in accelerated MRI techniques within the imaging plane, leveraging large datasets to instruct models in image reconstruction. These models can be repurposed for SMS reconstruction by training them on pairs of SMS-accelerated and fully sampled k-space data or via self-supervised approaches that eliminate the need for ground truth. However, these methods' robustness may be questioned when confronted with data derived from diverse acquisition protocols, aliasing patterns, and varied coil sensitivity distributions.

Embodiments provide a robust and fast image reconstruction method for reconstructing SMS MRI. Embodiments integrate a plug-and-play (PnP) method into the diffusion sampling framework in order to provide a reconstruction algorithm referred to as SMS Diffusion PnP. Unlike current PnP methods that rely on discriminative Gaussian denoisers, SMS Diffusion PnP inherits the generative ability of diffusion models. In particular, a denoising diffusion probabilistic model (DDPM) is used that expresses image generation as a temporal Markov process with T steps forwards and reverse for the diffusion process. The forward process adds random Gaussian noise to an image, while the reverse process constructs desired data samples from the Gaussian noise.

The SMS Diffusion PnP model is trained with a large dataset of high-quality complex-valued MRI datasets, for example using the entire image directly or only using patches of images to reduce data and computation requirements. The patch coordinate in the original image is included as an additional channel, while the patch size is randomized and diversified throughout training to encode the cross-region dependency at multiple scales. For 2D SMS MRI reconstruction, the input slice location is further input to handle a wide range of aliasing patterns stemming from the complexity of the SMS imaging forward model, which is affected by the variations in SMS factors (the number of simultaneous acquired slices), FOV shift patterns, and additional in-plane acceleration factors.

Image reconstruction may be improved and made more robust. The use of diffusion models provides better generative abilities than generative adversarial networks (GANs) and variational autoencoders (VAEs). However, the slow inference speed of diffusion models typically limits their use in clinical applications. Embodiments solve these issues by adapting a quadratic sequence from Denoising Diffusion Implicit Models (DDIMs) for sampling, which has more sampling steps at low-noise regions. This allows for the sampling sequence (length T) to be a subset of N used in training the diffusion prior. As a result, the SMS Diffusion PnP method described herein can produce detailed images with less than 100 neural function evaluations (NFEs) and thus provide quicker results.

The SMS Diffusion PnP method further offers high-quality image reconstruction and strong generalization capabilities, potentially benefiting numerous applications. The SMS Diffusion PnP method may be combined with other tasks, such as image super-resolution (requiring adjustments to data consistency) to achieve even higher acceleration factors or enhance the quality of the resulting images. The SMS Diffusion PnP method may also accommodate different user preferences for the reconstructed image impression through tuning Diffusion PnP hyperparameters, for example λ and (, that control the strength of the condition guidance and the level of noise injected at each timestep.

The position-aware (for example, added as additional coordinate channels) aspects of the SMS Diffusion PnP further provide accurate reconstruction of SMS MRI data, particularly in challenging situations such as protocols with few, thin slices with small gaps (e.g., sagittal spine).

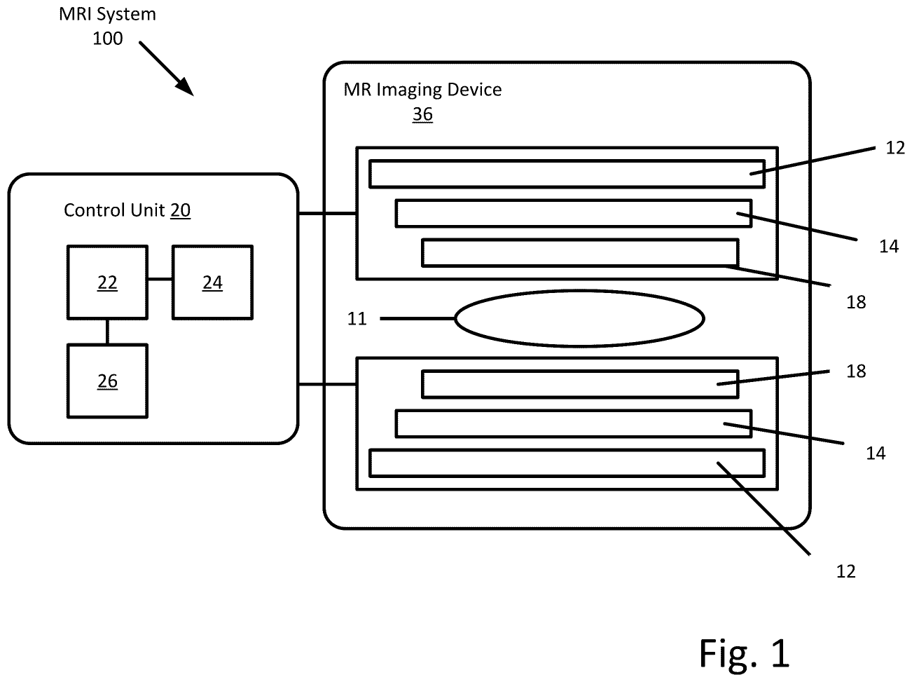

FIG. 1 depicts an example system 100 for magnetic resonance imaging and Simultaneous Multi-slice (SMS) MRI Reconstruction using denoising diffusion models. The examples described herein use a SMS magnetic resonance (MR) context (i.e., a magnetic resonance scanner), but the reconstruction techniques and models may be used for other MR acquisitions and other medical imaging procedures such as computed tomography (CT) or positron emission tomography (PET) where applicable. The examples may further use knee and brain SMS MRI procedures as examples, but any organ or region may be imaged by the system 100. The system 100 use a generative diffusion model(s) to reconstruct/restore (denoise, upscale, refine etc.) an image from medical imaging data acquired by an MR scanner 36 of a patient 11. The MR system 100 includes an MR imaging device 36, control unit 20, and/or a server. The MR imaging device 36 is only exemplary, and a variety of MR scanning systems may be used to collect the MR data. The MR imaging device 36 (also referred to as a MR scanner or image scanner) is configured to scan a patient 11. The MR imaging device 36 scans a patient 11 to provide k-space measurements (measurements in the frequency domain). The MR system 100 further includes the control unit 20 that is configured to process the MR signals and generate (reconstruct) images of the object or patient 11 for display to an operator or further analysis. The control unit 20 includes a processor 22 that is configured to execute instructions, or the method described herein. The control unit 20 may store the MR signals and images in a memory 24 for later processing or viewing. The control unit 20 may include a display 26 for presentation of images to an operator.

In the MR system 100, magnetic coils 12 create a static base or main magnetic field B0 in the body of patient 11 or an object positioned on a table and imaged. Within the magnet system are gradient coils 14 for producing position dependent magnetic field gradients superimposed on the static magnetic field. Gradient coils 14, in response to gradient signals supplied thereto by a gradient and control unit 20, produce position dependent and shimmed magnetic field gradients in three orthogonal directions and generate magnetic field pulse sequences. The shimmed gradients compensate for inhomogeneity and variability in an MR imaging device magnetic field resulting from patient anatomical variation and other sources. The control unit 20 may include a RF (radio frequency) module that provides RF pulse signals to RF coil 18. The RF coil 18 produces magnetic field pulses that rotate the spins of the protons in the imaged body of the patient 11 by ninety degrees or by one hundred and eighty degrees for so-called “spin echo” imaging, or by angles less than or equal to 90 degrees for “gradient echo” imaging. Gradient and shim coil control modules in conjunction with RF module, as directed by control unit 20, control slice-selection, phase-encoding, readout gradient magnetic fields, radio frequency transmission, and magnetic resonance signal detection, to acquire magnetic resonance signals representing planar slices of the patient 11. In response to applied RF pulse signals, the RF coil 18 receives MR signals, e.g., signals from the excited protons within the body as the protons return to an equilibrium position established by the static and gradient magnetic fields. The MR signals are detected and processed by a detector within RF module and the control unit 20 to provide an MR dataset to a processor 22 for processing into an image.

In some embodiments, the processor 22 is located in the control unit 20, in other embodiments, the processor 22 is located remotely. A two or three-dimensional k-space storage array of individual data elements in a memory 24 of the control unit 20 stores corresponding individual frequency components including an MR dataset. The k-space array of individual data elements includes a designated center, and individual data elements individually include a radius to the designated center. The magnetic field generator (including coils 12, 14 and 18) generates a magnetic field for use in acquiring multiple individual frequency components corresponding to individual data elements in the storage array. A storage processor in the control unit 20 stores individual frequency components acquired using the magnetic field in corresponding individual data elements in the array. The row and/or column of corresponding individual data elements alternately increases and decreases as multiple sequential individual frequency components are acquired. The magnetic field generator acquires individual frequency components in an order corresponding to a sequence of substantially adjacent individual data elements in the array, and magnetic field gradient change between successively acquired frequency components is substantially minimized.

During an imaging procedure, the MR imaging device 36 is configured by the imaging protocol to scan a region of a patient 11 using a SMS acquisition protocol. SMS acquisition is a high-speed MRI technique that excites and reads out multiple slices simultaneously, significantly reducing scan time while maintaining image quality. Unlike conventional sequential slice-by-slice acquisitions, SMS uses multi-band RF excitation, parallel imaging, and controlled aliasing strategies to acquire multiple slices in a single repetition time (TR). In SMS acquisitions, a multi-band RF pulse is designed to excite multiple slices simultaneously. This is achieved by summing multiple frequency components into a single RF pulse, each corresponding to a different slice location. The result is that multiple slices experience the same excitation and generate signals at the same time, effectively collapsing multiple slices into a single acquisition. To facilitate slice separation during reconstruction, SMS acquisitions employ Controlled Aliasing in Parallel Imaging (CAIPI). In a conventional SMS acquisition without CAIPI, aliased slices appear directly overlapping, making separation difficult. CAIPI overcomes this by applying slice-dependent phase shifts during excitation or readout, which disperses the aliased slices in the spatial domain. These shifts help condition the reconstruction problem, reducing g-factor noise and improving signal-to-noise ratio (SNR). The effectiveness of SMS acquisition depends on the number of slices excited simultaneously (slice acceleration factor, MB factor). For example, an MB factor of 4 means four slices are acquired at once, leading to a 4× reduction in scan time. However, higher MB factors introduce challenges such as increased RF power deposition (SAR), greater reconstruction complexity, and potential slice leakage artifacts.

The control unit 20 is configured to reconstruct an image using the acquired MRI data from the imaging procedure. Image reconstruction may be performed by the system 100 or other computing devices. MRI image reconstruction is the process of converting raw data from an MRI scan into a clinical image. It is a critical step in the MRI process, as the quality of the reconstructed image can affect the accuracy of the diagnosis. In particular, when using accelerated MRI such as SMS, the reconstruction/restoration of the MRI images is important as the acquired imaging data may be sparse and thus provide an initial image/data that is, for example, noisy. Noisy images may be difficult to interpret and may result in inaccurate diagnoses.

Reconstructing SMS data involves the separation of aliased slice signals that are simultaneously acquired during a single readout. Since multiple slices are excited and acquired together, they overlap in k-space, and a dedicated reconstruction process is required to unalias them. The key components of SMS reconstruction are parallel imaging techniques, CAIPI, and advanced reconstruction algorithms such as SENSE (Sensitivity Encoding) and GRAPPA (Generalized Autocalibrating Partially Parallel Acquisition).

SENSE solves the inverse problem directly in image space. The aliased signal from the SMS acquisition is modeled as a linear combination of the true slice signals, weighted by the coil sensitivity profiles. A system of equations is constructed for each voxel, and matrix inversion techniques are used to solve for the individual slice signals. The key requirement for SENSE-based SMS reconstruction is accurate coil sensitivity maps, which may be derived from a separate calibration scan. GRAPPA reconstructs missing k-space lines by utilizing the correlation between acquired k-space data points. In SMS imaging, the slice separation process involves reconstructing each individual slice from a combination of aliased k-space data using auto-calibration signals (ACS). The GRAPPA kernel learns how different coil channels contribute to slice-specific signal patterns and applies this learned information to separate the overlapping slices.

In embodiments described herein, image reconstruction/restoration uses a generative deep learning framework, for example diffusion models, for reconstructing/restoring images from acquired SMS MRI data. The generative deep learning model utilizes prior knowledge either with (supervised) or without (unsupervised) knowledge of a specific reconstruction task. By decoupling learning of the prior knowledge from the reconstruction task, the diffusion models may overcome existing issues of costly training and poor robustness to varied scan parameters.

MRI acquisitions may be slow, for example requiring long scan times and patient discomfort. Increased acceleration using SMS may result in more noise or other artifacts that need to be removed or fixed during reconstruction. The resulting sparse data may be reconstructed/restored using deep learning generative methods. Diffusion models (DMs) are a class of deep generative neural networks configured to sample from an unknown data distribution. One known diffusion model implementation is referred to as a Denoising Diffusion Probabilistic Model (DDPM). DDPMs are a type of generative model that learn to generate complex data distributions by iteratively refining noisy samples. Diffusion models include a forward diffusion process and a reverse diffusion process. In the forward diffusion process noise is added to an image over multiple time steps, effectively transforming it into a random noise distribution. In the reverse diffusion process, the model denoises the noisy image step by step, effectively recovering the original data distribution. In SMS MRI reconstruction, DDPMs leverage these processes to generate high-fidelity images from undersampled k-space data (the raw data acquired by MRI scanners) and/or restore noisy or otherwise deficient images.

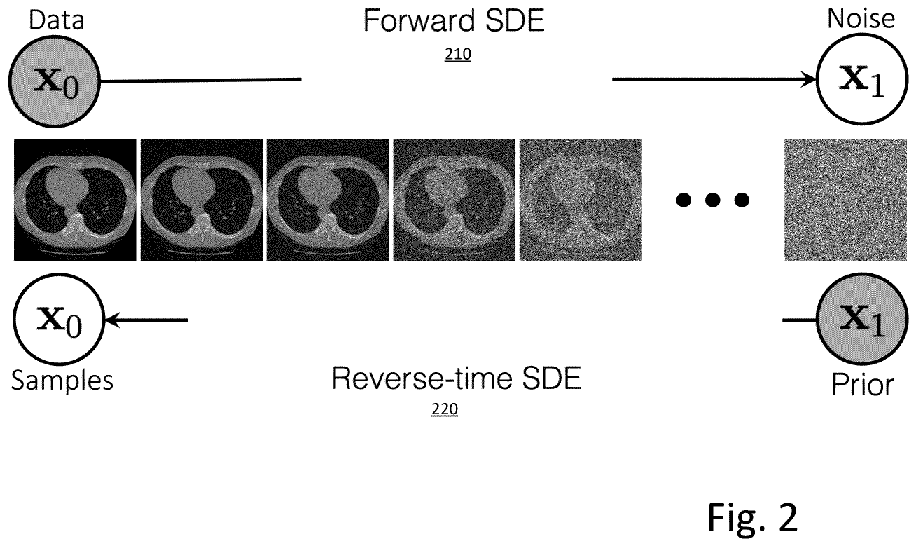

FIG. 2 depicts an example of a generative diffusion process for image processing including the forward process 210 and the reverse process 220 (also referred to as the inference stage). The goal of the diffusion model is to learn the diffusion process for a given dataset, such that the process can generate new elements that are distributed similarly as the original dataset. In the forward stochastic differential equation (SDE) noise is added to the input image over and over again until the image is practically all noise. At each step, the diffusion model learns how to map images to their corresponding noise-free measurements. In the reverse step, the learned diffusion model is used to recover the data by reversing this noising process. Image reconstruction in MRI is a similar inverse problem that attempts to find an image from noisy scan measurements. To solve the inverse problem a forward model is defined that maps noisy MR images to their corresponding noise-free measurements. As measurements become noisier (for example as scan time is reduced) or less complete (for example when using increased acceleration), the resulting image reconstruction problem becomes highly ill-posed, meaning it has no stable, unique solution. In such situations the acquired measurements are said to be sparse, i.e., they are generally insufficient to uniquely specify a finite-dimensional approximation of the sought-after object, even in the absence of measurement noise or errors related to modeling the imaging system. False structures may arise due to the reconstruction method incorrectly estimating parts of the object that either did not contribute to the observed measurement data or cannot be recovered in a stable manner, a phenomenon that is referred to as hallucinations. Hallucinations may be resolved by incorporating information about the distribution of probable images, so-called prior knowledge. The reconstructed image balances maximizing both the likelihood that explains measurements, and the prior, that is, the probability that is a valid medical image. In embodiments described herein, the diffusion models capture rich image priors from underlying data distributions. From a Bayesian perspective, the diffusion models learn the a priori probability density function of the images. Solving the Bayesian inverse problem is tantamount to drawing posterior samples (and/or computing the posterior mean) from the posterior density function that is a product of the likelihood function (physical and statistical model of the imaging system) and the learnt a priori probability density function.

Embodiments combine a plug-and-play image reconstruction method with the diffusion sampling framework to accurately restore complex SMS MRI data regarding reconstruction faithfulness and perceptual quality with a limited number of neural function evaluations (NFEs).

In an embodiment, the plug-and-play image reconstruction methods separate the following optimization problem's data and the prior term using the Half Quadratic Splitting (HQS) algorithm. This allows the method to solve the decoupled subproblems iteratively and leverage the diffusion sampling framework. By introducing an auxiliary variable, the problem may be split into the following subproblems and solved iteratively:

$${z}_{k} = {arg min}_{z} \frac{1}{2 {( \sqrt{\frac{λ}{μ}} )}^{2}} {‖ z - {f}_{k} ‖}^{2} + P ( z )$$

$${f}_{k - 1} = {arg min}_{x} {‖ G - [ H ] f ‖}^{2} + {μσ}_{n}^{2} {‖ f - {z}_{k} ‖}^{2}$$

The subproblem with the prior term is a Gaussian denoising problem and the subproblem with the data term is a proximal operator that has a closed-form solution that depends on H. The prior term ensures that the generated sample is from the prior data distribution (here learned by a diffusion model), while the data term refines the image manifold based on the given measurement. A fast solution may be computed based on the estimated image from the diffusion model (denoiser) for MRI image reconstruction tasks such as image denoising, image inpainting, and super-resolution. However, for the reconstruction of 2D SMS MRI, the solution may be provided as a first-order proximal operator when there is no analytical solution:

$${{f}^{\text{?}}}_{0}^{( t )} \approx {f}_{0}^{( t )} - {\frac{{\overline{σ}}_{t}^{2}}{2 λσ}}_{\text{?}}^{2} {∇}_{{f}_{0}^{( t )}} {‖ G - [ H ] {f}_{0}^{( t )} ‖}^{2}$$

$$\text{?} \text{indicates text missing or illegible when filed}$$

The SMS models are incorporated into this solution. In particular, the SMS forward imaging model includes encoding multiple 2D slices by different coil sensitivity maps, phase cycling for CAIPI shifts, and the summation of signals into a single 2D matrix. Hence, SMS data consistency for s simultaneously acquired slices can be written as:

$${{f}^{\text{?}}}_{0}^{( t )} \approx {f}_{0}^{( t )} - {\frac{{\overline{σ}}_{t}^{2}}{2 λσ}}_{n}^{2} {( AR )}^{H} ( AR {f}_{0}^{( t )} - y ) f = \{ {f}^{1} , {f}^{2} , … {f}^{\text{?}} \}$$

$$\text{?} \text{indicates text missing or illegible when filed}$$

Where R represent the combined data reordering operations of readout concatenation and CAIPI shift, and A represent the SENSE encoding operator, which can be expressed as A=M·F·C where M is the kspace subsampling mask, F is the 2D Fourier transform, and C is the coil sensitivity map.

The CAIPI shift improves slice separation and reduces noise amplification by introducing controlled spatial offsets between simultaneously acquired slices. CAIPI introduces a controlled shift to each slice so that they do not directly overlap. By distributing aliased slices across the field-of-view, the coil sensitivity profiles can more effectively distinguish between them, leading to improved separation and lower noise amplification.

The SENSE (Sensitivity Encoding) operator is a mathematical model that relates the aliased multi-slice signal to the individual slice signals using the spatial sensitivity profiles of the receiver coil array. When multiple slices are excited and acquired simultaneously, their signals become superimposed due to the inherent aliasing in SMS acquisitions. The SENSE encoding operator is used to separate these slices by leveraging the unique coil sensitivity variations across space. The SENSE encoding operator constructs a system matrix using coil sensitivities and inverts it using regularization techniques to achieve optimal separation. The accuracy of this process depends on the coil geometry and the conditioning of the encoding matrix, which can be improved using CAIPI shifts to minimize noise amplification.

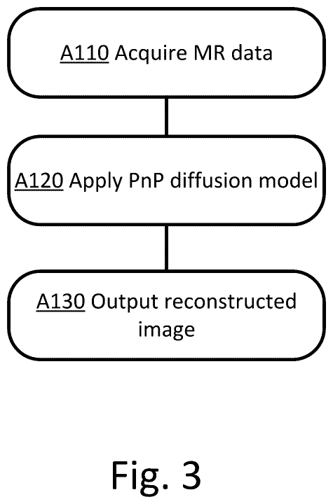

FIG. 3 depicts a method for plug-and-play simultaneous multi-slice MRI reconstruction using denoising diffusion models. The method is performed by the system of FIG. 1 or another system. The method is performed in the order shown or other orders. Additional, different, or fewer acts may be provided.

At act A110, medical imaging data of a patient is acquired. The medical imaging data may be acquired using an MRI scanning system such as described in FIG. 1. Alternatively, the medical imaging data may be provided from another source such as a database or previous scan. The medical imaging data may be acquired using an accelerated sequence, for example using an acceleration factor of two or more (six or more, eight or more, etc.). The accelerated acquisition provides sparse data. With a higher acceleration factor, the time to complete an exam is lowered along with the quality of the acquired data. In an embodiment, an MRI system 100 acquires k-space measurements that are used to generate an initial reconstructed image that is input into the diffusion process as described below.

The acquisition of the medical imaging data is performed using SMS. SMS provides simultaneous excitation of multiple slices using a single radiofrequency (RF) pulse modulated with different phase shifts. At the excitation stage, a multi-band RF pulse is applied, which consists of a superposition of frequency components targeting different slice locations. Unlike conventional slice-selective RF pulses that excite only a single slice, SMS pulses encode multiple slices at once, leveraging frequency and phase encoding manipulations. This multi-band excitation introduces inherent aliasing, as the signals from different slices overlap in k-space. The single radiofrequency (RF) pulse modulated with different phase shifts ensure that the signals from different slices can be separated later during image reconstruction. Conventional MRI acquires slices sequentially, whereas SMS imaging dramatically increases acquisition efficiency by encoding multiple slices within the same repetition time (TR), effectively shortening overall scan duration.

At act A120, the medical imaging data is iteratively refined/reconstructed using a diffusion PnP model, wherein for each step of an iterative process of the diffusion PnP model, a pretrained diffusion model is used to remove noise to predict a next state of the iterative process and a data consistency step is applied that incorporates a SMS imaging model.

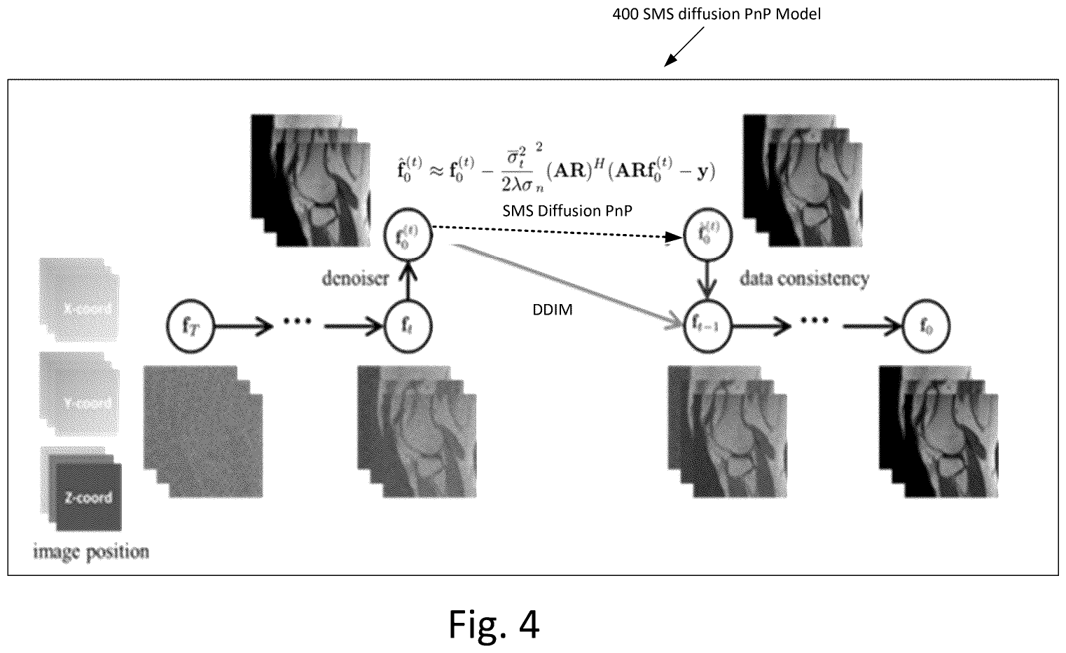

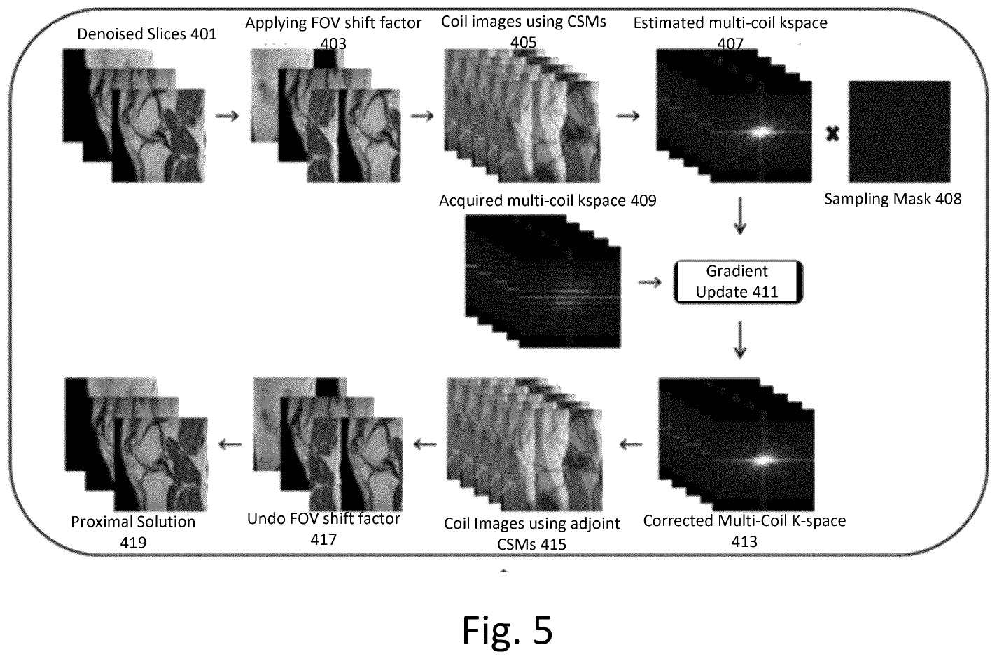

FIGS. 4 and 5 depict a diffusion plug-and-play method for reconstructing SMS MRI data is SMS diffusion PnP. FIG. 4 depicts one iteration of the SMS diffusion PnP model 400. the SMS images are input into the SMS diffusion PnP model 400 which provides denoising and data consistency. The next iteration is provided by the sampling rate based on DDIM.

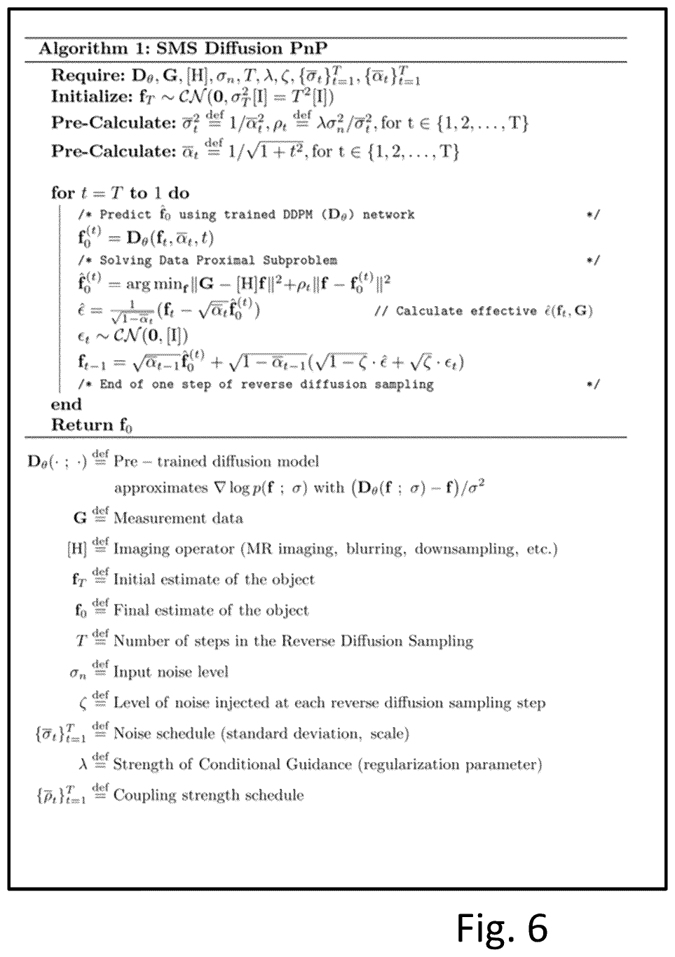

FIG. 5 depicts a more detailed view of the data consistency step. In FIG. 5, denoised slices 401 are acquired, a FOV shift factor is applied 403, Coil images using coil sensitivity maps (CSMs) are provided 405. Multi-coil kspace is estimated 407 and combined with the sampling mask 408 along with the acquired multi-coil kspace 409 for a gradient update 411 which provides the corrected multi-coil k-space 413. The coil images are generated using adjoint CSMs 415. The FOV shift factor 417 is undone. The output is the proximal solution 419. This process is further described below in the SMS diffusion PnP algorithm provided in FIG. 6.

The diffusion PnP model includes measurement data for data consistency during reverse diffusion steps. In the reverse process 210, an image is generated using the learned probability density function of contrast weighted MR image data while being constrained by a data consistency term G that represents expected/known measurements. The measurement data (G) may include measurements/linear transform of known features of the region or objects being scanned. For example, the measurement data (G) may include a ratio of the sizes or distances of or between two different features. This measurement is carried out after a correction step that accounts for the inaccurate estimation resulting from computing the proximal solution. The measurement data (G) is incorporated by solving the data proximal subproblem as follows:

$${{f}^{´}}_{0}^{( t )} = arg {min}_{f} {‖ G - [ H ] f ‖}^{2} + {p}_{t} {‖ f - {f}_{0}^{( t )} ‖}^{2}$$

which can also be determined as:

$${\hat{f}}_{0}^{( t )} \approx {f}_{0}^{( t )} - \frac{{\overline{σ}}_{t}^{{2}^{2}}}{2 {λσ}_{n}} {∇}_{{f}_{0}^{( t )}} {‖ G - [ H ] {f}_{0}^{( t )} ‖}^{2}$$

which for SMS can be stated as:

$${\hat{f}}_{0}^{( t )} \approx {f}_{0}^{( t )} - \frac{{\overline{σ}}_{t}^{{2}^{2}}}{2 {λσ}_{n}} {( AR )}^{H} ( {ARf}_{0}^{( t )} - y ) f = \{ {f}^{1} , {f}^{2} , … {f}^{*} \}$$

Where R represent the combined data reordering operations of readout concatenation and CAIPI shift, and A represent the SENSE encoding operator, which can be expressed as A=M·F·C where M is the kspace subsampling mask, F is the 2D Fourier transform, and C is the coil sensitivity map. This process is further described in relation to FIG. 5 above.

An example of an algorithm of the full method, titled SMS diffusion PnP, is provided in FIG. 6. The algorithm combines the traditional plug-and-play method with the diffusion sampling framework to accurately restore complex MRI data regarding reconstruction faithfulness and perceptual quality. As described above, the diffusion process is split into forward and reverse diffusion processes. The forward diffusion process is a process of turning an image into noise, and the reverse diffusion process is supposed to turn that noise into the image again. The reverse process 210 starts with a noisy image. The process continuously denoises the image over and over again to steer it in a particular direction. The value T describes how many inference steps will be taken during this process. The number of steps is also referred to as Neural Function Evaluations (NFEs). The higher the value, the more steps that are taken to produce the image (also more time).

In an embodiment, the algorithm uses DDPM for the diffusion model. In an embodiment, in the reverse process, sampling is adapted from Deep Diffusion Implicit Models (DDIM). DDIM accelerates the sampling process of diffusion models by using non-Markovian diffusion processes. This approach allows for faster generation of high-quality images while maintaining the same training objective as traditional diffusion models. Implicit models focus on representing functions implicitly rather than explicitly. Instead of defining a mathematical formula directly, the implicit model defines a set of equations that describe the relationship between inputs and outputs without specifying the exact function.

The sampling process in DDIM involves sampling from the prior distribution and then iteratively sampling from the conditional distributions. This process is faster than traditional diffusion models because it does not require simulating the entire Markov chain. The number of NFEs, e.g. the total number of times the neural network needs to be called during the sampling process to generate a new image, is typically significantly lower in a DDIM compared to a standard DDPMs due to DDIM's more efficient non-Markovian diffusion process, resulting in faster generation times with fewer computations required. For example, fewer than 50 or 100 NFEs may be required to provide an acceptable output.

In an embodiment, a quadratic sampling technique is used. Sampling involves iteratively refining an image from a noisy initialization by stepping backward through a predefined sequence of time steps. The choice of these steps significantly impacts the efficiency and quality of image reconstruction. In a quadratic sampling scheme, the time steps are spaced according to a quadratic function, meaning the interval between successive steps increases quadratically as the sampling process progresses. This contrasts with uniform or geometric schedules, where the time steps are either equally spaced or decrease exponentially. The quadratic approach provides finer resolution in the early stages of denoising, when large noise components must be accurately removed, while allowing larger steps in later stages when the image structure has already stabilized. The use of this approach ensures that the early steps focus more on fine-grained denoising while later steps consolidate the reconstructed image. Different sampling techniques within diffusion models, like DPM-Solver or optimized ODE solvers, may also be used to adjust the required NFE.

In an embodiment, the PnP model is a trained neural network. In an embodiment, the network is trained to learn the inverse diffusion process, for example to progressively recover clean images from noisy versions. The training of the network may be performed at any point prior to application. The training process starts with a dataset of high-quality images that are systematically corrupted by adding noise through a series of time steps. The goal of training is to teach the model to reverse this degradation and reconstruct the original images with high fidelity. In an embodiment, the training phase follows a modified diffusion framework where the model learns to predict the noise at each step, conditioned on the noisy input. The model is trained using a loss function, for example a mean squared error (MSE) between the predicted and true noise components, ensuring that the model accurately estimates the noise distribution. By minimizing this loss across multiple training examples, the model refines its ability to denoise images across different levels of corruption.

Another key aspect of training the diffusion model for image reconstruction is the parameterization of the noise schedule. The diffusion model learns a mapping between different noise levels and the corresponding clean images, enabling it to reconstruct missing or degraded information effectively. By leveraging the learned implicit sampling trajectories, for example as adapted from DDIMs, the diffusion model may generate high-quality images with significantly fewer denoising steps compared to traditional diffusion models. Once training is complete, the diffusion model may be evaluated using test images to ensure that it generalizes well to unseen data. Metrics such as peak signal-to-noise ratio (PSNR) and structural similarity index (SSIM) may be used to assess the quality of reconstructed images. Hyperparameters such as noise schedules and network architectures may be fine-tuned to improve the performance. Through this iterative training process, the diffusion model is trained to be highly effective at reconstructing high-quality images from noisy or incomplete inputs.

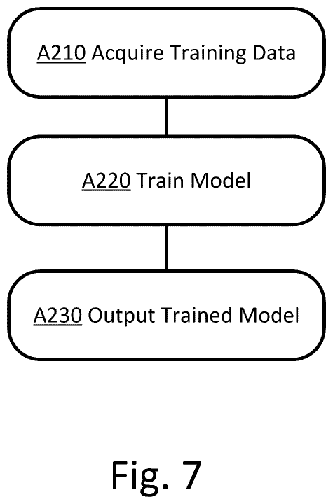

FIG. 7 depicts an example workflow for training the diffusion model. The method is performed by the system of FIG. 1 or another system. The method is performed in the order shown or other orders. Additional, different, or fewer acts may be provided.

At act A210, training data is acquired. The training data may include a dataset of medical image data that represents the style and subject matter that the diffusion model is configured to generate. Different sets of training data may be used for different models that are used for different purposes. For example, training data of the knee may be used to train a model for generating knee images, while training data of the brain may be used to train a model for generating brain images. In an example, the model was trained on a diverse dataset of around 300,000 2D images from various body regions, such as the brain, knee, and prostate. The dataset included different magnetic field strengths (1.5T, 3T, and 7T) and imaging sequences like TSE, DWI, and HASTE, sourced from private and public datasets, including fast MRI. In this example, the model included a resolution of 256×256 and a total capacity of 0.7 billion parameters. In another example, the pre-trained prior model may be trained with a large dataset of high-quality complex-valued MRI datasets. This may be done using the entire image directly or only using patches of images to reduce data and computation requirements. A patch coordinate from the original image is included as an additional channel, while the patch size is randomized and diversified throughout training to encode the cross-region dependency at multiple scales. For 2D SMS MRI reconstruction, it is also vital to incorporate the input slice location to handle a wide range of aliasing patterns stemming from the complexity of the SMS imaging forward model, which is affected by the variations in SMS factors (the number of simultaneous acquired slices), FOV shift patterns, and additional in-plane acceleration factors.

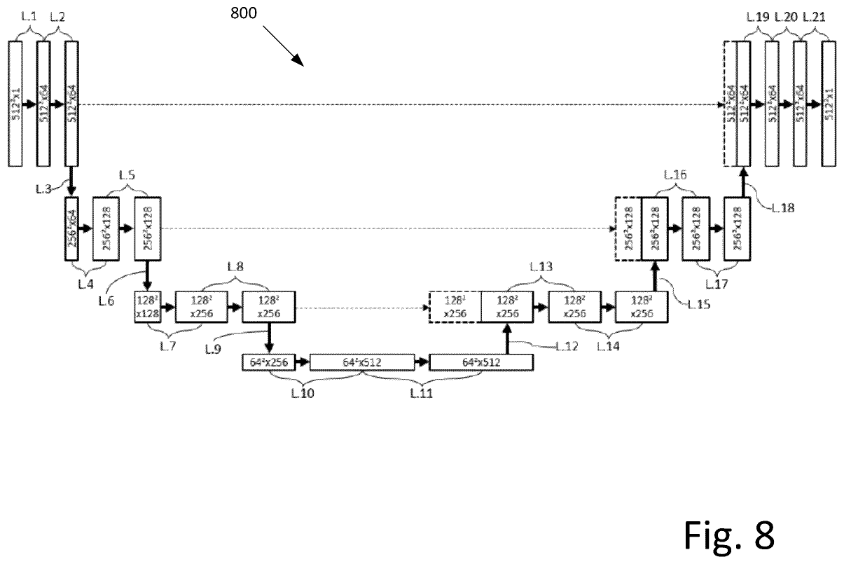

At act A220, a model to estimate a MR image is trained by finding the reverse transitions that maximize the likelihood of the training data. In an embodiment, the model is a generative model, in particular a diffusion model, for example, a DDPM or DDIM. In the learning phase, the forward process 210 learns the probability density function of MR image data by adding noise to the input image data. Different training mechanisms may be used, such as reparameterization or score-based generative modeling. In an embodiment, the diffusion model is trained in pixel space for complex-valued MRI data, employing a single diffusion prior from a diverse MR image dataset, enabling a universal framework for various inverse problems and clinical applications. In an embodiment, the model is based on is a convolutional neural network, in particular, a convolutional neural network having a U-net structure, for example as displayed in FIG. 8. The input data to the machine learning network 800 in FIG. 8 is a two-dimensional medical image comprising 512×512 pixel, every pixel comprising one intensity value (e.g., relating to the Hounsfield units of the respective pixels). The machine learning network 800 comprises convolutional layers (indicated by solid, horizontal arrows), pooling layers (indicating by solid arrows pointing down), and upsampling layers (indicated by solid arrows pointing up), the number of the respective nodes is indicated within the boxes. Within the U-net structure first the input images are downsampled (decreasing the size of the im-ages and increasing the number of channels), afterwards they are upsampled (increasing the size of the images and decreasing the number of channels) to generate a transformed image.

All except the last convolutional layers L.1, L.2, L.4, L.5, L.7, L.8, L.10, L.11, L.13, L.14, L.16, L.17, L.19, L.20 use 3×3 kernels with a padding of 1, the ReLU activation function, and a number of filters/convolutional kernels that matches the number of channels of the respective node layers as indicated in FIG. 8. The last convolutional layer uses a 1×1 kernel with no padding and the ReLU activation function.

The pooling layers L.3, L.6, L.9 are max-pooling layers, replacing four neighboring nodes with only one node, the value being the maximum of the values of the four neighboring nodes. The upsampling layers L.12, L.15, L.18 are transposed convolution layers with 3×3 kernels and stride 2, which effectively quadruple the number of nodes. The dashed horizontal errors correspond to concatenation operations, where the output of a convolutional layer L.2, L.5, L.8 of the downsampling branch of the U-net structure is used as additional inputs for a convolutional layer L.13, L.16, L.19 of the upsampling branch of the U-net structure. This additional input data is treated as additional channels in the input node layer for the convolutional layer L.13, L.16, L.19 of the upsampling branch.

At act A230, the trained model for denoising the MR image is output. The model may be applied to newly acquired MRI data in order to generate MR image data.

Referring back to FIG. 3, at Act A130, reconstructed medical image(s) of the patient are output. The operator interface 26 of the system of FIG. 1 includes an input device and an output device. The input may be an interface, such as interfacing with a computer network, memory, database, medical image storage, or other source of input data. The input may be a user input device, such as a mouse, trackpad, keyboard, roller ball, touch pad, touch screen, or another apparatus for receiving user input. The output is a display device but may be an interface. The reconstructed/restored images are displayed. For example, a high resolution image of a region of the patient 11 is displayed. The display is a CRT, LCD, plasma, projector, printer, or other display device. The display is configured by loading an image to a display plane or buffer. The display is configured to display the image of the region of the patient 11. The operator interface may include a graphical user interface (GUI) enabling user interaction with the medical imaging device and enables user modification or selections in substantially real time.

In an embodiment, the medical imaging device is an MR imaging device 36, for example, as described above in FIG. 1. The MR system 100 of FIG. 1 includes an MR scanner 36 or system, a computer based on data obtained by MR scanning, a server, or another processor 22. The MR imaging device 36 is only exemplary, and a variety of MR scanning systems may be used to collect the MR data. The MR imaging device 36 (also referred to as a MR scanner or image scanner) is configured to scan a patient 11. The MR imaging device 36 scans a patient 11 to provide k-space measurements (measurements in the frequency domain).

The processor 22 may include an image processor that generates images using a machine learning network (machine learning model). The image processor is a general processor, digital signal processor, three-dimensional data processor, graphics processing unit, application specific integrated circuit, field programmable gate array, artificial intelligence processor, digital circuit, analog circuit, combinations thereof, or another now known or later developed device for image generation. The image processor is a single device, a plurality of devices, or a network. For more than one device, parallel or sequential division of processing may be used. Different devices making up the image processor may perform different functions. In one embodiment, the image processor is also a control processor or other processor of the imaging device. Other image processors of the imaging device or external to the imaging device may be used. The image processor 22 is configured by software, firmware, and/or hardware to process the SMS data acquired by the imaging device and output one or more reconstructed images.

The instructions for implementing the processes, methods, and/or techniques discussed herein are provided on non-transitory computer-readable storage media or memories, such as a cache, buffer, RAM, removable media, hard drive, or other computer readable storage media, for example the memory. The instructions are executable by the processor or another processor. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the instructions set, storage media, processor or processing strategy and may be performed by software, hardware, integrated circuits, firmware, micro code, and the like, operating alone or in combination. In one embodiment, the instructions are stored on a removable media device for reading by local or remote systems. In other embodiments, the instructions are stored in a remote location for transfer through a computer network. In yet other embodiments, the instructions are stored within a given computer, CPU, GPU, or system. Because some of the constituent system components and method steps depicted in the accompanying figures may be implemented in software, the actual connections between the system components (or the process steps) may differ depending upon the manner in which the present embodiments are programmed.

In an embodiment, the processor 22 implements one or more machine learning networks that are stored in the memory. In general, a trained machine learning network mimics cognitive functions that humans associate with other human minds. In particular, by training based on training data the machine learning network is able to adapt to new circumstances and to detect and extrapolate patterns. Another term for “trained machine learning network” is “trained function”. In general, parameters of a machine learning network can be adapted by means of training. In particular, supervised training, semi-supervised training, unsupervised training, reinforcement learning and/or active learning can be used. Furthermore, representation learning (an alternative term is “feature learning”) can be used. In particular, the parameters of the machine learning networks can be adapted iteratively by several steps of training. In particular, within the training a certain cost function can be minimized. In particular, within the training of a neural network the backpropagation algorithm can be used. In particular, a machine learning network may comprise a neural network, a support vector machine, a decision tree and/or a Bayesian network, and/or the machine learning network can be based on k-means clustering, Q-learning, genetic algorithms, and/or association rules. In particular, a neural network can be a deep neural network, a convolutional neural network, or a convolutional deep neural network. Furthermore, a neural network can be an adversarial network, a deep adversarial network, and/or a generative adversarial network.

In an embodiment, the processor 22 implements a diffusion process for training and configuring the model. The diffusion process includes forward diffusion and reverse diffusion. Forward diffusion is used to add noise to the input image using a schedule which determines how much noise is added at the given step t. Reverse diffusion consists of multiple steps in which a small amount of noise is removed at every step. In an embodiment, the diffusion models use a modified U-Net architecture, for example as described above in

FIG. 8. In an embodiment, the model(s) are provided by or implemented with a neural network trained using deep learning. The network(s) may be defined as a plurality of sequential feature units or layers. Sequential is used to indicate the general flow of output feature values from one layer to input to a next layer. The information from the next layer is fed to a next layer, and so on until the final output. The layers may only feed forward or may be bi-directional, including some feedback to a previous layer. The nodes of each layer or unit may connect with all or only a sub-set of nodes of a previous and/or subsequent layer or unit. Skip connections may be used, such as a layer outputting to the sequentially next layer as well as other layers. Rather than pre-programming the features and trying to relate the features to attributes, the deep architecture is defined to learn the features at different levels of abstraction the input data. The features are learned to reconstruct lower level features (i.e., features at a more abstract or compressed level). For example, features for generating a fused image or higher resolution image are learned. For a next unit, features for reconstructing the features of the previous unit are learned, providing more abstraction. Each node of the unit represents a feature. Different units are provided for learning different features.

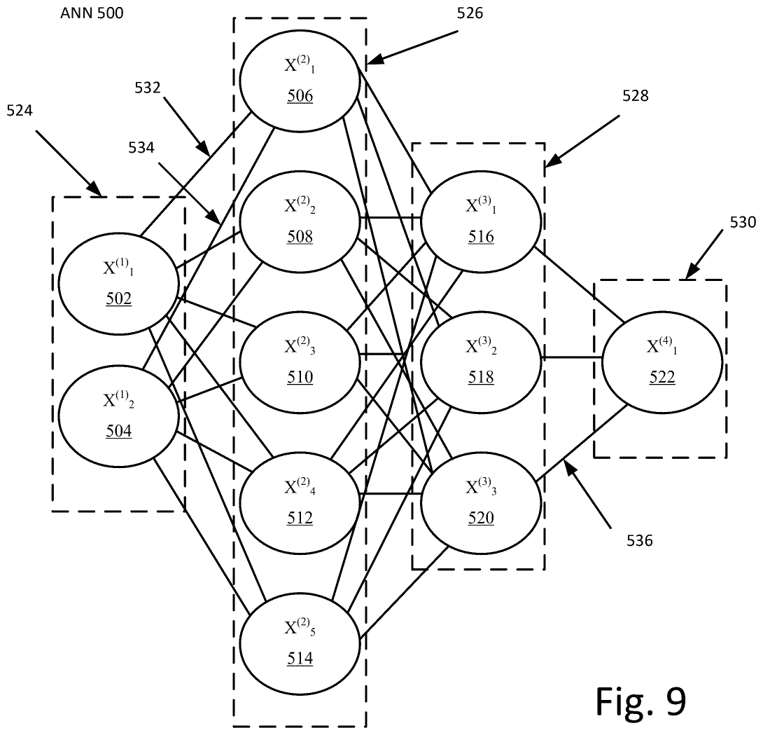

Various units or layers may be used, such as convolutional, pooling (e.g., max-pooling), deconvolutional, fully connected, or other types of layers. Within a unit or layer, any number of nodes is provided. For example, 100 nodes are provided. Later or subsequent units may have more, fewer, or the same number of nodes. In general, for convolution, subsequent units have more abstraction. FIG. 9 shows an embodiment of an artificial neural network (ANN) 500, in accordance with one or more embodiments. Alternative terms for “artificial neural network” are “neural network”, “artificial neural net” or “neural net”. The artificial neural network 500 may be used in part in, for example, the one or more machine learning based networks utilized for the diffusion model, etc.

The artificial neural network 500 includes nodes 502-522 and edges 532, 534, . . . , 536, wherein each edge 532, 534, . . . , 536 is a directed connection from a first node 502-522 to a second node 502-522. In general, the first node 502-522 and the second node 502-522 are different nodes 502-522, it is also possible that the first node 502-522 and the second node 502-522 are identical. For example, in FIG. 9, the edge 532 is a directed connection from the node 502 to the node 506, and the edge 534 is a directed connection from the node 504 to the node 506. An edge 532, 534, . . . , 536 from a first node 502-522 to a second node 502-522 is also denoted as “ingoing edge” for the second node 502-522 and as “outgoing edge” for the first node 502-522.

In this embodiment, the nodes 502-522 of the artificial neural network 500 may be arranged in layers 524-530, wherein the layers may include an intrinsic order introduced by the edges 532, 534, . . . , 536 between the nodes 502-522. In particular, edges 532, 534, . . . , 536 may exist only between neighboring layers of nodes. In the embodiment shown in FIG. 9, there is an input layer 524 including only nodes 502 and 504 without an incoming edge, an output layer 530 including only node 522 without outgoing edges, and hidden layers 526, 528 in-between the input layer 524 and the output layer 530. In general, the number of hidden layers 526, 528 may be chosen arbitrarily. The number of nodes 502 and 504 within the input layer 524 usually relates to the number of input values of the neural network 500, and the number of nodes 522 within the output layer 530 usually relates to the number of output values of the neural network 500.

In particular, a (real) number may be assigned as a value to every node 502-522 of the neural network 500. Here, x⁽ⁿ⁾ᵢ denotes the value of the i-th node 502-522 of the n-th layer 524-530. The values of the nodes 502-522 of the input layer 524 are equivalent to the input values of the neural network 500, the value of the node 522 of the output layer 530 is equivalent to the output value of the neural network 500. Furthermore, each edge 532, 534, . . . , 536 may include a weight being a real number, in particular, the weight is a real number within the interval [−1, 1] or within the interval [0, 1]. Here, w^{(m,n)}_{i,j} denotes the weight of the edge between the i-th node 502-522 of the m-th layer 524-530 and the j-th node 502-522 of the n-th layer 524-530. Furthermore, the abbreviation w ( ) j is defined for the weight w^{(n,n+1)}_{i,j}.

In particular, to calculate the output values of the neural network 500, the input values are propagated through the neural network. In particular, the values of the nodes 502-522 of the (n+1)-th layer 524-530 may be calculated based on the values of the nodes 502-522 of the n-th layer 524-530 by

$${x}_{j}^{( n + 1 )} = f ( {\sum }_{i} {x}_{i}^{( n )} \cdot {w}_{i , j}^{( n )} ) .$$

Herein, the function f is a transfer function (another term is “activation function”). Known transfer functions are step functions, sigmoid function (e.g. the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 524 are given by the input of the neural network 500, wherein values of the first hidden layer 526 may be calculated based on the values of the input layer 524 of the neural network, wherein values of the second hidden layer 528 may be calculated based in the values of the first hidden layer 526, etc.

In order to set the values w^{(m,n)}_{i,j} for the edges, the neural network 500 has to be trained using training data. In particular, training data includes training input data and training output data (denoted as tᵢ). For a training step, the neural network 500 is applied to the training input data to generate calculated output data. In particular, the training data and the calculated output data include a number of values, said number being equal with the number of nodes of the output layer.

In particular, a comparison between the calculated output data and the training data is used to recursively adapt the weights within the neural network 500 (backpropagation algorithm). In particular, the weights are changed according to

$${w}_{i , j}^{( n )} = {w}_{i , j}^{( n )} - γ \cdot {δ}_{j}^{( n )} \cdot {x}_{i}^{( n )}$$

wherein γ is a learning rate, and the numbers δ⁽ⁿ⁾ⱼ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δ⁽ⁿ⁺¹⁾ⱼ, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 530, wherein f′ is the first derivative of the activation function, and y⁽ⁿ⁺¹⁾ⱼ is the comparison training value for the j-th node of the output layer 530.

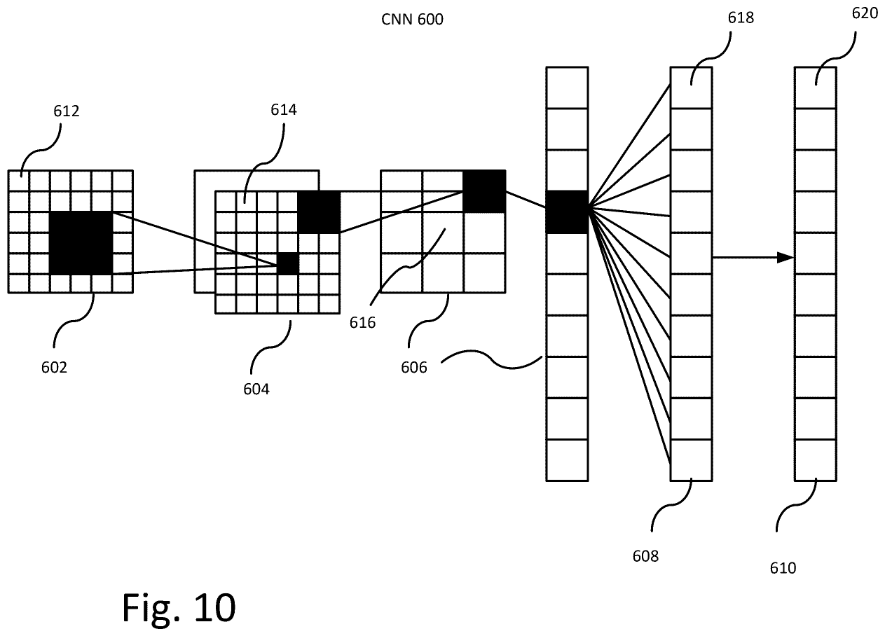

FIG. 10 shows a convolutional neural network (CNN) 600, in accordance with one or more embodiments. Machine learning networks described herein, such as, e.g., the diffusion model etc. may be implemented using convolutional neural network 600.

In the embodiment shown in FIG. 10 the convolutional neural network includes 600 an input layer 602, a convolutional layer 604, a pooling layer 606, a fully connected layer 608, and an output layer 610. Alternatively, the convolutional neural network 600 may include several convolutional layers 604, several pooling layers 606, and several fully connected layers 608, as well as other types of layers. The order of the layers may be chosen arbitrarily, usually fully connected layers 608 are used as the last layers before the output layer 610.

In particular, within a convolutional neural network 600, the nodes 612-620 of one layer 602-610 may be considered to be arranged as a d-dimensional matrix or as a d-dimensional image. In particular, in the two-dimensional case the value of the node 612-620 indexed with i and j in the n-th layer 602-610 may be denoted as x⁽ⁿ⁾_{[i,j]}. However, the arrangement of the nodes 612-620 of one layer 602-610 does not have an effect on the calculations executed within the convolutional neural network 600 as such, since these are given solely by the structure and the weights of the edges.

In particular, a convolutional layer 604 is characterized by the structure and the weights of the incoming edges forming a convolution operation based on a certain number of kernels. In particular, the structure and the weights of the incoming edges are chosen such that the values x⁽ⁿ⁾ₖ of the nodes 614 of the convolutional layer 604 are calculated as a convolution x⁽ⁿ⁾ₖ=Kₖ*x⁽ⁿ⁻¹⁾ based on the values x⁽ⁿ⁻¹⁾ of the nodes 612 of the preceding layer 602, where the convolution * is defined in the two-dimensional case as:

$${x}_{k}^{( n )} [ i , j ] = ( {K}_{k} * {x}^{( n - 1 )} ) [ i , j ] = {\sum }_{{i}^{′}} {\sum }_{{j}^{′}} {K}_{k} [ {i}^{′} , {j}^{′} ] \cdot {x}^{( n - 1 )} [ i - {i}^{′} , j - {j}^{′} ] .$$

Here the k-th kernel Kk is a d-dimensional matrix (in this embodiment a two-dimensional matrix), which is usually small compared to the number of nodes 612-618 (e.g. a 3×3 matrix, or a 5×5 matrix). In particular, this implies that the weights of the incoming edges are not independent, but chosen such that they produce said convolution equation. In particular, for a kernel being a 3×3 matrix, there are only 9 independent weights (each entry of the kernel matrix corresponding to one independent weight), irrespectively of the number of nodes 612-620 in the respective layer 602-610. In particular, for a convolutional layer 604, the number of nodes 614 in the convolutional layer is equivalent to the number of nodes 612 in the preceding layer 602 multiplied with the number of kernels.

If the nodes 612 of the preceding layer 602 are arranged as a d-dimensional matrix, using a plurality of kernels may be interpreted as adding a further dimension (denoted as “depth” dimension), so that the nodes 614 of the convolutional layer 604 are arranged as a (d+1)-dimensional matrix. If the nodes 612 of the preceding layer 602 are already arranged as a (d+1)-dimensional matrix including a depth dimension, using a plurality of kernels may be interpreted as expanding along the depth dimension, so that the nodes 614 of the convolutional layer 604 are arranged also as a (d+1)-dimensional matrix, wherein the size of the (d+1)-dimensional matrix with respect to the depth dimension is by a factor of the number of kernels larger than in the preceding layer 602.

The advantage of using convolutional layers 604 is that spatially local correlation of the input data may exploited by enforcing a local connectivity pattern between nodes of adjacent layers, in particular by each node being connected to only a small region of the nodes of the preceding layer.

In the embodiment shown in FIG. 10, the input layer 602 includes 36 nodes 612, arranged as a two-dimensional 6×6 matrix. The convolutional layer 604 includes 72 nodes 614, arranged as two two-dimensional 6×6 matrices, each of the two matrices being the result of a convolution of the values of the input layer with a kernel. Equivalently, the nodes 614 of the convolutional layer 604 may be interpreted as arranges as a three-dimensional 6×6×2 matrix, wherein the last dimension is the depth dimension.

A pooling layer 606 may be characterized by the structure and the weights of the incoming edges and the activation function of its nodes 616 forming a pooling operation based on a non-linear pooling function f. For example, in the two dimensional case the values x⁽ⁿ⁾ of the nodes 616 of the pooling layer 606 may be calculated based on the values x⁽ⁿ⁻¹⁾ of the nodes 614 of the preceding layer 604 as

$${x}^{( n )} [ i , j ] = f ( {x}^{( n - 1 )} [ {id}_{1} , {jd}_{2} ] , … , {x}^{( n - 1 )} [ {id}_{1} + {d}_{1} - 1 , {jd}_{2} + {d}_{2} - 1 ] )$$

In other words, by using a pooling layer 606, the number of nodes 614, 616 may be reduced, by replacing a number d1·d2 of neighboring nodes 614 in the preceding layer 604 with a single node 616 being calculated as a function of the values of said number of neighboring nodes in the pooling layer. In particular, the pooling function f may be the max-function, the average, or the L2-Norm. In particular, for a pooling layer 606 the weights of the incoming edges are fixed and are not modified by training.

The advantage of using a pooling layer 606 is that the number of nodes 614, 616 and the number of parameters is reduced. This leads to the amount of computation in the network being reduced and to a control of overfitting.

In the embodiment shown in FIG. 10, the pooling layer 606 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

A fully-connected layer 608 may be characterized by the fact that a majority, in particular, all edges between nodes 616 of the previous layer 606 and the nodes 618 of the fully-connected layer 608 are present, and wherein the weight of each of the edges may be adjusted individually.

In this embodiment, the nodes 616 of the preceding layer 606 of the fully-connected layer 608 are displayed both as two-dimensional matrices, and additionally as non-related nodes (indicated as a line of nodes, wherein the number of nodes was reduced for a better presentability). In this embodiment, the number of nodes 618 in the fully connected layer 608 is equal to the number of nodes 616 in the preceding layer 606. Alternatively, the number of nodes 616, 618 may differ.

A convolutional neural network 600 may also include a ReLU (rectified linear units) layer or activation layers with non-linear transfer functions. In particular, the number of nodes and the structure of the nodes contained in a ReLU layer is equivalent to the number of nodes and the structure of the nodes contained in the preceding layer. In particular, the value of each node in the ReLU layer is calculated by applying a rectifying function to the value of the corresponding node of the preceding layer.

The input and output of different convolutional neural network blocks may be wired using summation (residual/dense neural networks), element-wise multiplication (attention) or other differentiable operators. Therefore, the convolutional neural network architecture may be nested rather than being sequential if the whole pipeline is differentiable.

In particular, convolutional neural networks 600 may be trained based on the backpropagation algorithm. For preventing overfitting, methods of regularization may be used, e.g. dropout of nodes 612-620, stochastic pooling, use of artificial data, weight decay based on the L1 or the L2 norm, or max norm constraints. Different loss functions may be combined for training the same neural network to reflect the joint training objectives. A subset of the neural network parameters may be excluded from optimization to retain the weights pretrained on another datasets.

While the invention has been described above by reference to various embodiments, many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

The following is a list of non-limiting illustrative embodiments disclosed herein:

Illustrative embodiment 1: A method for diffusion plug and play (PnP) image reconstruction of medical imaging data, the method comprising: acquiring simultaneous multi-slice (SMS) medical imaging data of a patient; iteratively refining the SMS medical imaging data using a SMS diffusion PnP model, wherein for each step of an iterative process of the SMS diffusion PnP model, a pretrained diffusion model is used to remove noise to predict a next state of the iterative process and a data consistency step is applied that incorporates a SMS imaging model; and outputting reconstructed SMS medical imaging data of the patient.

Illustrative embodiment 2. The method of illustrative embodiment 1, wherein the medical imaging data is acquired with an acceleration factor of two or more.

Illustrative embodiment 3. The method of illustrative embodiment 1, wherein the data consistency step comprises solving a data proximal subproblem.

Illustrative embodiment 4. The method of illustrative embodiment 3, wherein the data proximal subproblem comprises:

$${\hat{f}}_{0}^{( t )} \approx {f}_{0}^{( t )} - \frac{{\overline{σ}}_{t}^{{2}^{2}}}{2 {λσ}_{n}} {( AR )}^{H} ( {ARf}_{0}^{( t )} - y ) f = \{ {f}^{1} , {f}^{2} , … {f}^{*} \}$$

wherein R represent a combined data reordering operations of readout concatenation and CAIPI shift, wherein A represent a SENSE encoding operator that is expressed as A=M·F·C where M is a kspace subsampling mask, F is a 2D Fourier transform, and C is a coil sensitivity map.

Illustrative embodiment 5. The method of illustrative embodiment 1, wherein the diffusion PnP model generates the reconstructed SMS medical imaging data with fewer than 100 Neural Function Evaluations (NFES).

Illustrative embodiment 6. The method of illustrative embodiment 1, wherein the SMS diffusion PnP uses a quadratic sequence for sampling.

Illustrative embodiment 7. The method of illustrative embodiment 6, wherein there are more sampling steps at low-noise regions than high-noise regions.

Illustrative embodiment 8. The method of illustrative embodiment 1, wherein pretrained diffusion model comprises a trained Denoising Diffusion Probabilistic Model (DDPM).

Illustrative embodiment 9. The method of illustrative embodiment 8, further comprising: tuning diffusion PnP hyperparameters that control a strength of a condition guidance and/or a level of noise injected at each timestep of the iterative refinement.

Illustrative embodiment 10. A system for diffusion plug and play (PnP) image reconstruction of magnetic resonance (MR) data, the system comprising: a medical imaging device configured to acquire simultaneous multi-slice (SMS) medical imaging data of a patient; a memory configured to store a model configured to reconstruct one or more MR images when input the SMS medical imaging data, wherein the model is configured to iteratively refine the SMS medical imaging data using diffusion, wherein for each step of the iterative process, a pretrained diffusion model is used to remove noise to predict a next state of the iterative process and data consistency is performed by solving a data proximal subproblem; and a processor configured to reconstruct and/or restore the reconstruct one or more MR images from the SMS medical imaging data using the model.

Illustrative embodiment 11. The system of illustrative embodiment 10, wherein the SMS medical imaging data is acquired with an acceleration factor of two or more.

Illustrative embodiment 12. The system of illustrative embodiment 10, wherein the data proximal subproblem comprises:

$${\hat{f}}_{0}^{( t )} \approx {f}_{0}^{( t )} - \frac{{\overline{σ}}_{t}^{{2}^{2}}}{2 {λσ}_{n}} {( AR )}^{H} ( {ARf}_{0}^{( t )} - y ) f = \{ {f}^{1} , {f}^{2} , … {f}^{*} \}$$

wherein R represent a combined data reordering operations of readout concatenation and CAIPI shift, wherein A represent a SENSE encoding operator that is expressed as A=M·F·C where M is a kspace subsampling mask, F is a 2D Fourier transform, and C is a coil sensitivity map.

Illustrative embodiment 13. The system of illustrative embodiment 10, wherein the model generates the reconstructed SMS medical imaging data with fewer than 100 Neural Function Evaluations (NFES).

Illustrative embodiment 14. The system of illustrative embodiment 10, wherein the model uses a quadratic sequence for sampling.

Illustrative embodiment 15. The system of illustrative embodiment 14, wherein there are more sampling steps at low-noise regions than high-noise regions.

Illustrative embodiment 16. The system of illustrative embodiment 10, wherein the model uses a trained Denoising Diffusion Probabilistic Model (DDPM) for diffusion.

Illustrative embodiment 17. The system of illustrative embodiment 10, further comprising: a user interface configured to receive inputs for tuning diffusion hyperparameters that control a strength of a condition guidance and/or a level of noise injected at each timestep of the iterative refinement.

Illustrative embodiment 18. A method for diffusion plug and play (PnP) image reconstruction of medical imaging data, comprising: acquiring, by an magnetic resonance scanner, simultaneous multi-slice (SMS) medical imaging data; iteratively reconstructing the SMS medical imaging data using a SMS diffusion PnP model that includes data consistency during reverse diffusion steps; and outputting a reconstructed image.

Illustrative embodiment 19. The method of illustrative embodiment 18, wherein the SMS diffusion PnP model is based on a Denoising Diffusion Implicit Model and supports fast sampling.

Illustrative embodiment 20. The method of illustrative embodiment 18, wherein the data consistency is applied by solving a data proximal subproblem comprising:

$${\hat{f}}_{0}^{( t )} \approx {f}_{0}^{( t )} - \frac{{\overline{σ}}_{t}^{{2}^{2}}}{2 {λσ}_{n}} {( AR )}^{H} ( {ARf}_{0}^{( t )} - y ) f = \{ {f}^{1} , {f}^{2} , … {f}^{*} \}$$

wherein R represent a combined data reordering operations of readout concatenation and CAIPI shift, wherein A represent a SENSE encoding operator that is expressed as A=M·F·C where M is a kspace subsampling mask, F is a 2D Fourier transform, and C is a coil sensitivity map.

1. A method for diffusion plug and play (PnP) image reconstruction of medical imaging data, the method comprising:
acquiring simultaneous multi-slice (SMS) medical imaging data of a patient;
iteratively refining the SMS medical imaging data using a SMS diffusion PnP model, wherein for each step of an iterative process of the SMS diffusion PnP model, a pretrained diffusion model is used to remove noise to predict a next state of the iterative process and a data consistency step is applied that incorporates a SMS imaging model; and
outputting reconstructed SMS medical imaging data of the patient.

2. The method of claim 1, wherein the medical imaging data is acquired with an acceleration factor of two or more.

3. The method of claim 1, wherein the data consistency step comprises solving a data proximal subproblem.

4. The method of claim 3, wherein the data proximal subproblem comprises:
$${\hat{f}}_{0}^{( t )} \approx {f}_{0}^{( t )} - \frac{{\overline{σ}}_{t}^{{2}^{2}}}{2 {λσ}_{n}} {( AR )}^{H} ( {ARf}_{0}^{( t )} - y ) f = \{ {f}^{1} , {f}^{2} , … {f}^{*} \}$$
wherein R represent a combined data reordering operations of readout concatenation and CAIPI shift, wherein A represent a SENSE encoding operator that is expressed as A=M·F·C where M is a kspace subsampling mask, F is a 2D Fourier transform, and C is a coil sensitivity map.

5. The method of claim 1, wherein the diffusion PnP model generates the reconstructed SMS medical imaging data with fewer than 100 Neural Function Evaluations (NFES).

6. The method of claim 1, wherein the SMS diffusion PnP uses a quadratic sequence for sampling.

7. The method of claim 6, wherein there are more sampling steps at low-noise regions than high-noise regions.

8. The method of claim 1, wherein pretrained diffusion model comprises a trained Denoising Diffusion Probabilistic Model (DDPM).

9. The method of claim 8, further comprising:
tuning diffusion PnP hyperparameters that control a strength of a condition guidance and/or a level of noise injected at each timestep of the iterative refinement.

10. A system for diffusion plug and play (PnP) image reconstruction of magnetic resonance (MR) data, the system comprising:
a medical imaging device configured to acquire simultaneous multi-slice (SMS) medical imaging data of a patient;
a memory configured to store a model configured to reconstruct one or more MR images when input the SMS medical imaging data, wherein the model is configured to iteratively refine the SMS medical imaging data using diffusion, wherein for each step of the iterative process, a pretrained diffusion model is used to remove noise to predict a next state of the iterative process and data consistency is performed by solving a data proximal subproblem; and
a processor configured to reconstruct and/or restore the reconstruct one or more MR images from the SMS medical imaging data using the model.

11. The system of claim 10, wherein the SMS medical imaging data is acquired with an acceleration factor of two or more.

12. The system of claim 10, wherein the data proximal subproblem comprises:
$${\hat{f}}_{0}^{( t )} \approx {f}_{0}^{( t )} - \frac{{\overline{σ}}_{t}^{{2}^{2}}}{2 {λσ}_{n}} {( AR )}^{H} ( {ARf}_{0}^{( t )} - y ) f = \{ {f}^{1} , {f}^{2} , … {f}^{*} \}$$
wherein R represent a combined data reordering operations of readout concatenation and CAIPI shift, wherein A represent a SENSE encoding operator that is expressed as A=M·F·C where M is a kspace subsampling mask, Fis a 2D Fourier transform, and C is a coil sensitivity map.

13. The system of claim 10, wherein the model generates the reconstructed SMS medical imaging data with fewer than 100 Neural Function Evaluations (NFES).

14. The system of claim 10, wherein the model uses a quadratic sequence for sampling.

15. The system of claim 14, wherein there are more sampling steps at low-noise regions than high-noise regions.

16. The system of claim 10, wherein the model uses a trained Denoising Diffusion Probabilistic Model (DDPM) for diffusion.

17. The system of claim 10, further comprising:
a user interface configured to receive inputs for tuning diffusion hyperparameters that control a strength of a condition guidance and/or a level of noise injected at each timestep of the iterative refinement.

18. A method for diffusion plug and play (PnP) image reconstruction of medical imaging data, comprising:
acquiring, by an magnetic resonance scanner, simultaneous multi-slice (SMS) medical imaging data;
iteratively reconstructing the SMS medical imaging data using a SMS diffusion PnP model that includes data consistency during reverse diffusion steps; and
outputting a reconstructed image.

19. The method of claim 18, wherein the SMS diffusion PnP model is based on a Denoising Diffusion Implicit Model and supports fast sampling.

20. The method of claim 18, wherein the data consistency is applied by solving a data proximal subproblem comprising:
$${\hat{f}}_{0}^{( t )} \approx {f}_{0}^{( t )} - \frac{{\overline{σ}}_{t}^{{2}^{2}}}{2 {λσ}_{n}} {( AR )}^{H} ( {ARf}_{0}^{( t )} - y ) f = \{ {f}^{1} , {f}^{2} , … {f}^{*} \}$$
wherein R represent a combined data reordering operations of readout concatenation and CAIPI shift, wherein A represent a SENSE encoding operator that is expressed as A=M·F·C where M is a kspace subsampling mask, F is a 2D Fourier transform, and C is a coil sensitivity map.
